(19) United States
(12) Patent Application Publication
(10) Pub. No.: US 2021/0027722 A1
(43) Pub. Date: Jan. 28, 2021

(54) Adaptive Low Power Touch and Display Device

(71) Applicant: Microsoft Technology Licensing, LLC, Redmond, WA (US)

(72) Inventors: Linghui Rao, Bothell, WA (US); Paul W. Martin, Loveland, CO (US); Matthew D. Morris, Seattle, WA (US); Rajesh Manohar Dighde, Redmond, WA (US); Kabir Siddiqui, Sammamish, WA (US); Andrew N. Cady, Hartland, WI (US); Andrew Bodley, Fort Collins, CO (US)

(73) Assignee: Microsoft Technology Licensing, LLC, Redmond, WA (US)

(21) Appl. No.: 16/520,952

(22) Filed: Jul. 24, 2019

(51) Int. Cl. G09G 3/34; G06F 3/041

(52) U.S. Cl. CPC G09G 3/342; G09G 2330/021; G06F 3/0416; G06F 3/0412

(57) ABSTRACT

A method that enables an adaptive low power display device is described herein. The method includes determining a blocked area of a panel display, wherein the panel display is to render one or more images and deriving a segmented area of the display based on the blocked area of the display. The method also includes adjusting a segment of a backlight of the panel display that is proximate to the blocked area of the panel display according to a sparse array configuration, wherein the backlight is non-uniform in emitting light.

### BACKGROUND

Display devices and modules enable a visual output of information. Often, a display device includes a panel display coupled with a backlight. Further, the display device may also include an input device, such as a touch screen. The touch screen may be positioned on top of the panel display. The touch screen enables the capture of touches or gestures at a touch sensor. The touches or gestures may be input to the touch screen via a body part of a user or a device. Additionally, the display device may be communicatively coupled with other accessories that are physically placed on top of the display device.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a method that enables an adaptive low power display device is described. The method includes determining a blocked area of a panel display, wherein the panel display is to render one or more images and deriving a segmented area of the display based on the blocked area of the display. The method also includes adjusting a segment of a backlight of the panel display that is proximate to the blocked area of the panel display according to a sparse array configuration, wherein the backlight is non-uniform in emitting light.

In another embodiment described herein, a system is described. The system comprises a display controller, wherein a panel display is to render images. The system further comprises a touch screen controller, wherein a touch screen is to interpret a touch input. Additionally, the system comprises a backlight controller, wherein a segment of a backlight that corresponds to a blocked area of the panel display is adjusted according to a sparse array configuration, and wherein the backlight is non-uniform in emitting light.

Another embodiment described herein includes a computer readable medium. The computer readable medium bears computer executable instructions which, when executed on a computing system comprising at least a processor, carry out a method for an adaptive low power touch and display module. The computer readable medium includes determining a blocked area of a panel display, wherein the panel display is to render one or more images and deriving a segmented area of the display based on the blocked area of the display. The computer readable medium also includes adjusting a segment of a backlight of the panel display that corresponds to the blocked area of the panel display according to a sparse array configuration, wherein the backlight is non-uniform in emitting light.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of a system that enables an adaptive low power touch and display device;

FIG. 2 is an illustration of content rendered on a panel display;

FIG. 3 is an illustration of content rendered on a panel display;

FIG. 4 is an illustration of content rendered on a panel display;

FIG. 5 is an illustration of a system that enables an adaptive low power touch and display device;

FIG. 6 is an illustration of a virtual track pad on a panel display;

FIG. 7 is a process flow diagram of an example method that enables an adaptive low power touch and display device;

FIG. 8 is a block diagram showing computer readable media that stores code for an adaptive low power touch and display device; and

FIG. 9 is a block diagram of an example of a computing system that can be used to enable an adaptive low power touch and display device.

### DETAILED DESCRIPTION

Display devices output content that is rendered in a visual format. For example, a display device may include panel display, such as a liquid-crystal display (LCD) or an organic light emitting diode (OLED) display. Moreover, the panel display may include an in-cell touch panel, wherein circuitry for a touch screen is embedded in an LCD. In some cases, the panel display may be coupled with a backlight to render visual content. For example, the backlight may be a light emitting diode (LED) backlight. The LED backlight may produce white light or red-green-blue (RGB) light to illuminate an LCD display. In the case of an OLED display, an organic layer or film of the OLED display may be electroluminescent. A touch screen may be layered on top of the panel display to enable touch functionality at the display device. The display device may be generally referred to as a screen.

Often, portions of the display are blocked, static, darkened, or otherwise unnecessary during operation. For example, when rendering a movie portions of the display may be darkened or static in order to create the appropriate screen size for rendering the movie. In another example, a display may be used to render a ticker of information across a portion of the panel display. In this example, the portion of the display that is not rendering the ticker may be darkened or static. Additionally, peripheral devices may be physically coupled with the display device such that segments of an area used to rendered visual content at the display device are blocked. In this example, the peripheral device may be placed on top of the display and can physically block segments of the display device from view. The segment of the display device underneath the peripheral device is not visible.

The segments of the display device that are blocked, occluded, or otherwise unnecessary are typically ignored by the user. Since these segments of the display are blocked from view or do not render visual information, processing the content to be rendered in these segments of the display is unnecessary. The processing associated with rendering blocked, static, or darkened segments can consume a portion of the processing resources of the display device, the computing device, or any combination thereof. In addition to consuming processing resources of the computing device or the display device, the processing associated with segments of the display that are blocked, static, or darkened consumes power. This power consumption may be undesirable, especially when power resources are limited.

The techniques described herein enable an adaptive low power touch and display device. The display device includes at least a panel display and a backlight. In embodiments, the display device includes an OLED display without a backlight. Additionally, in some embodiments the display device further includes a touch screen. According to the present techniques, segments of the display backlight may be powered off in response to a blocked, static, or darkened portion of the display device. In the case of an OLED display, segments of the electroluminescent layer may be powered off in response to a blocked, static, or darkened portion of the display device. In this manner, the segments of display backlight are adaptively configured to turn on and off. Power consumption attributed to display processing may be reduced. Moreover, processing resource consumption may also be reduced. In embodiments, an image processing function is applied to correct an artifact in the rendered content caused by a non-uniform illumination of the backlight or electroluminescent layer at the on/off segment boundaries. Further, a super glance mode enables a user to retrieve and review of notifications at the display device without CPU or GPU interaction.

As used herein, powered off may refer to the removal of power from a circuit that enables a functionality of the component. Powered on may refer to the restoration of power to a circuit that enables the functionality of the component. The component may also be otherwise disabled, such as being put in a low power mode or sleep mode. Moreover, being otherwise disabled may refer to a stop or halt of the component functionality. For example, a component such as a panel display may be powered off when power is removed from the panel display circuitry, thereby placing the panel display in an off state where no display is rendered. The panel display may also be otherwise disabled, wherein the display functionality of the panel display ceases.

In embodiments, the adaptive low power touch and display device as described herein enables a modification to content rendered at the display device based on real-world, physical blockages and occlusions of the display device. Conventionally, when a display device is operable content is rendered across the entire rendering area of the display device. The display device according to the present techniques determines a particular configuration of peripheral devices and if the use of the peripheral devices blocks or otherwise occludes a segment of the display device. The display device according to the present techniques can also determine segments of the display device that are static due to a lack of dynamic content being rendered in the segments. Being blocked, occluded, or lacking dynamic content results in a non-use of segments of the display device. The unused segments can be powered off or otherwise eliminated from processing, thereby saving processing resources, power, and life of the display device. Additionally, in embodiments processing of content rendered by the display device can be offloaded from the central processing unit (CPU) or the graphics processing unit (GPU). Instead, the present techniques enable communication between display electronics and other hardware elements distinct from CPU or GPU, which enables an extended battery life. In some embodiments, a virtual track pad functionality may be enabled so that a touch controller can logically scan/excite only the antennas in the track pad area to save power.

As used herein, a segment of the display device refers to an area or region of the display device that renders content. A segment refers to a same area of a panel display and a backlight. For example, consider a peripheral device that is shaped like a cylinder. The bottom, circular portion of the cylinder may rest on top of the display screen and block an area of the screen that corresponds to the circular footprint of the cylinder. According to the present techniques, a blocked segment of the display device is the circular area underneath the cylinder-like peripheral device. In particular, the blocked segment includes a blocked segment of the panel display and a blocked segment of the backlight that corresponds to the panel display. A segment or potion of a backlight may correspond to a segment or potion of the panel display when the segment or portion of the backlight is configured to provide illumination for the segment or portion of the panel display. Moreover, a segment or potion of a touch screen may correspond to a segment or potion of the panel display when the segment or portion of the touch screen is configured to capture a touch input in the segment or portion of the panel display. For ease of description, the present techniques are described as adjusting the light emitted by a backlight by powering on or powering off segments of the backlight. However, segments of any light source used to render content of a display device can be configured by powering on or powering off segments of the light source. For example, in the case of an OLED display, segments of an electroluminescent layer may be powered on or powered off according to the techniques described herein.

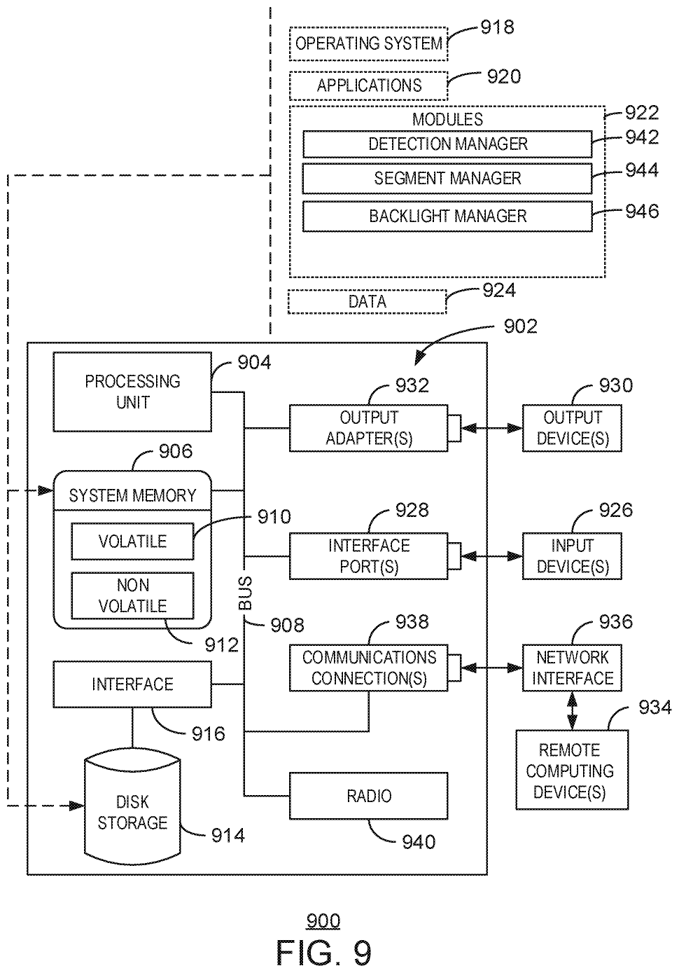

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 9 discussed below provides details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like. The communication media may include cables, such as fiber optic cables, coaxial cables, twisted-pair cables, and the like. Moreover, transmission media for wireless signals may include hardware that enables the transmission of wireless signals such as broadcast radio waves, cellular radio waves, microwaves, and infrared signals. In some cases, the transmission media for wireless signals is a component of a physical layer of a networking stack of an electronic device.

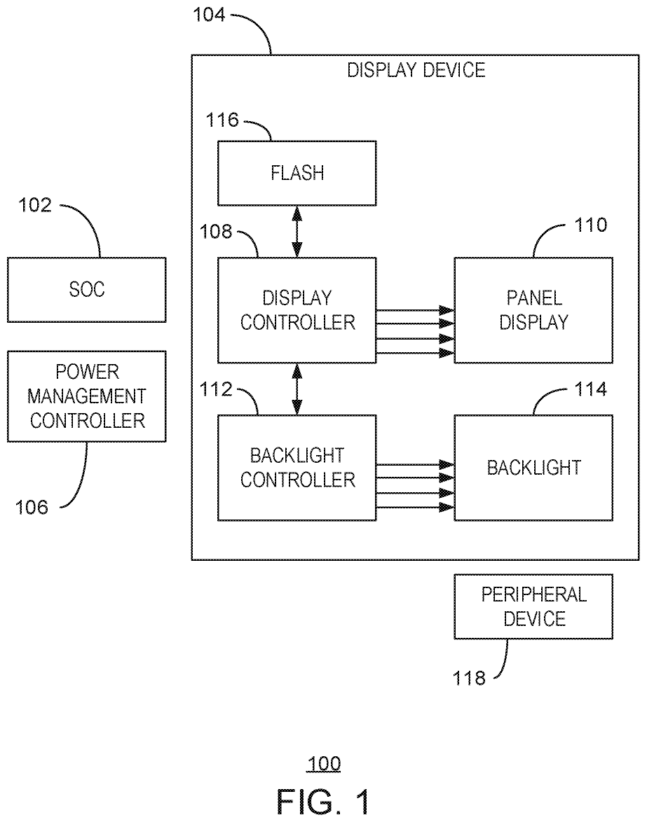

FIG. 1 is a block diagram of a system 100 that enables an adaptive low power touch and display device. The system 100 includes a system on chip (SoC) 102, a display device 104, and a power management controller 106. The SoC 102, display device 104, and power management controller may be communicatively coupled to enable functionality described herein, such enabling a reduction in power consumed by the display device, offloading image processing from a CPU/GPU, and a super glance mode.

In embodiments, the SoC 102 may be coupled with the display device 104 via a DisplayPort (DP)/embedded DP (eDP) interface. In particular, the SoC 102 may provide one or more processors (e.g., CPU 904) and/or memory components (e.g., memory 906) to execute an operating system and provide functionality based on inputs to the computing device and/or outputs from the computing device. Additionally, the SoC 102 can include a DP/eDP source for coupling to the display device 104 via an DP/eDP interface to facilitate displaying one or more images on a display, such as panel display 110.

Display device 104 can include a display controller 108. The display controller 108 may be, for example, a timing controller (TCON), a controller on a display driver integrated circuit (DDIC), or other hardware or software-implemented controller for receiving image data from a display port that interfaces with a computing device, and sending signals to the panel display 110 to display images or content. In embodiments, the panel display 110 may be a liquid crystal display (LCD), quantum dot (QD) display, organic light emitting diode (OLED) display, or substantially any type of embedded, external, wireless, etc. display coupled with a backlight to render the content. In embodiments, the panel display 110 includes a plurality of gate lines and a plurality of data lines arranged in a grid like fashion. Pixels may be located at intersection points of the grid formed by the gate lines and the data lines. During operation, the pixels are controlled by a switching element, such as a thin film transistor. The display controller may use source drivers to apply gamma voltages to corresponding data lines of the panel display to render content for particular gate lines.

The display device 104 also includes a backlight controller 112. The backlight controller 112 is coupled with the backlight 114. In embodiments, the backlight 114 is a light emitting diode (LED) backlight. The backlight controller 112 may be used to set a backlight value of the backlight 114. A backlight value may define an intensity of the luminance produced by an LED or a segment of LEDs. In embodiments, the backlight may be configured such that the backlight includes a plurality of independent solid-state light sources. For example, an LED backlight is comprised of a plurality of LEDs. The backlight 114 may be controlled by an algorithm executed by the backlight controller 112 to determine the intensity of each LED or LED segment of the backlight 114. For example, in some cases the luminance of the backlight 114 is derived from a luminance value of the content to be rendered.

The backlight 114 may be configured such that a number of segments of the backlight are electrically coupled by the same circuitry. In this manner, the solid-state light sources may be grouped into one or more segments that are electrically coupled by the same circuitry. A segment of light sources electrically coupled by the same circuitry may be referred to as a string. For ease of description, the present techniques illustrate a string of light sources as rectangular in shape. However, any shape of strings may be configured in a backlight or electroluminescent layer. Moreover, the adaptive touch and low power display device may segment the rendered content into segments of any shape. Additionally, as described herein content is rendered via the panel display 110 being illuminated by the backlight 114. In some cases, an OLED display enables the functionality of the panel display and backlight in the form of an electroluminescent layer. An OLED controller may render content and determine luminance values associated with the content. In embodiments, the OLED controller enables the functionality of the display controller and the backlight controller.

In embodiments, the display controller enables synchronization of data sent to the panel display 110 and the backlight 114 to render content. In order to synchronize this data transmission, the display controller may transmit a timing signal to the backlight controller. The display controller is able to control the transmission of information from the backlight controller 112 to the backlight 114 via the timing signal. As used herein, the term drive may refer to at least the transmission of data from a display controller to other components of the display device to cause content to be rendered in a visual format. For example, the panel display 110 may be driven by the display controller 108. The backlight 114 may be driven by a backlight controller 112. In embodiments, the backlight controller 112 may provide signals to the backlight 114 to adjust a brightness at which the images are displayed. The backlight controller 112 may also provide instructions to turn off a segment of LEDs of the backlight 114 while other remaining segments of LEDs the backlight 114 remain powered on.

Display device 104 can also include a flash memory 116 to store a glance image, which may be a high-resolution image for displaying on the panel display 110. Display device 104 may store multiple glance images for display in a slideshow, animation, or video form. Additionally, the power management controller 106 may regulate power consumption by the SoC 102 or display device 104. In particular, the power management controller may increase or decrease power to corresponding segments of LEDs in transitioning between power states. In embodiments, the power management controller 106 may be used to implement a power management scheme wherein segments of the backlight 114 are turned off in response to being blocked, static, or occluded. In particular, a portion of the panel display 110 may be blocked, static, or darkened during use or operation. For example, the panel display 110 may be blocked when it is positioned behind an object. In this scenario, a user may be willfully blocking a portion of the display. In another scenario, a peripheral device or accessory may be coupled with the panel display. The peripheral device or accessory may be configured to rest on top of the panel display. The portion of accessory that physically contacts the panel display may be configured to communicate or otherwise provide input to the panel display via a touch screen. As discussed below, input may be captured at a panel display via a touch screen or other screen-based input. In embodiments, the peripheral device may be a dial that rests on top of the panel display 110. The dial may be coupled with the SoC 102 wirelessly, and can control content rendered by the display device via this wireless communication.

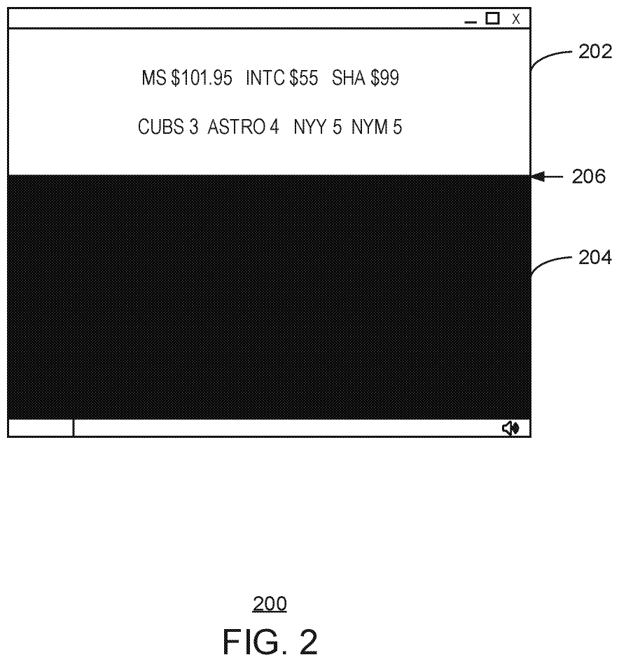

FIG. 2 is an illustration of content rendered on a panel display 200. In embodiments, the panel display 200 may be the panel display 110 of FIG. 1.

Additionally, in embodiments, the panel display 200 may be an LCD display. The panel display 200 may rest on top of a backlight. As illustrated, the panel display 200 and corresponding backlight are partitioned into a first segment 202 and a second segment 204. In the example of FIG. 2, a news-feed type application is rendering a news feed with news or sports scores going by. A part of the screen (more than half) will be darkened while the application is active. An adaptive low power touch and display device senses the configuration of the panel display. In response to this configuration, to save power, LEDs in the dark segments of the backlight may be powered off. An image processing function may be applied to portions of the panel display near the segment boundary 206 to compensate for artifacts on the panel display due to a reduction in intensity of neighboring light sources of the backlight.

In the examples of FIGS. 2-4, an image processing function may be executed to correct the image caused by the non-uniformity of backlight at the on/off segment boundaries. Image processing can be in done by any of the CPU, GPU, DSP, TCON or DDIC. The image processing function as described herein manipulates images to be rendered at the display device. In particular, the image processing function adjusts pixel values of the images to be rendered at the display device in view of the modified backlight scheme as described herein. For example, images to be rendered are processed with the presumption that all areas of a display will be used to render content. When portions of the backlight are adjusted, turned off, or lowered in intensity in response to a blocked, static, or darkened portion of the display device, anomalies in the rendered images may occur due to the adaptive backlight configuration. An image processing function takes as input the backlight configuration that includes a representation of the portion of the backlight that are adjusted, turned off, or lowered in intensity in response to a blocked, static, or darkened portion of the display device. The image processing function modifies the corresponding pixels of the image to eliminate any artifacts that may occur. In response to adjusting a segment of a backlight of the panel display that corresponds to the blocked area of the panel display, a display controller dynamically resizes the one or more images to conform to an active segment of the panel display. When the segment of the display device is no longer blocked, typical image processing is restored. In embodiments, the segment of the display device that was powered off is gradually restored.

As illustrated in FIG. 2, the first segment 202 corresponds to particular information that may continuously scroll across segment 202. For example, sports scores, news updates, stock information, and the like may be rendered continuously on a panel display. Often, such the rendered information is limited to one segment or portion of the panel display, while the remainder of the panel display is static. As illustrated, the second segment 204 is static and rendered as a black box. Often, a backlight controller receives image information for static portion of the display and processes this information to cause the backlight 114 to render a dark area. According to the present techniques, the backlight controller powers off segments of the backlight that are in proximity to the area that is blocked or static. The proximity is determined by a driver or OS composition engine which is aware of content rendered on the screen of the display device. Based on which segments are disabled, the values of a sparse array will be updated to provide the necessary compensation.

In particular, the luminance of discrete light sources of the backlight correspond to a sparse array of backlight values. Algorithms used to process and ultimately render pixel data are often based on vector multiplication used to calculate a final pixel value as multiplied by the correction coefficients. As used herein, the sparse array provides correction coefficients for each pixel to be rendered. The correction coefficients may be used to remove unwanted noise or to compensate for pixels with extreme luminance values, such as extremely bright or extremely dark luminance values. The vector multiplication implies multiple pixel corrections are calculated and applied to the display image in real time without perceivable latency. In embodiments, the configuration of the sparse array is pre-calculated for each combination of disabled backlight segments. In some cases, the configuration of the sparse array may be unique according to each panel display type or model. In embodiments, the present techniques include a single configuration of a sparse array per backlight mode for all panel displays that are the same type or model. Alternatively, the present techniques include a unique calibrated configuration for each panel display within a panel display model or type. In embodiments, the choice of a per-model static sparse array or per-panel calibrated sparse array results in a cost versus performance trade-off. A static sparse array for each panel display model enables a lower cost with a higher performance when compared to a calibrated, dynamic sparse array configuration. A uniquely calibrated, dynamic sparse array configuration for each panel display may result in a higher cost when compared to a panel display with a plurality of static sparse array configuration.

In the example of FIG. 1, the portion of the backlight that corresponds to the second segment 204 is powered off. In some cases, the portion of the backlight that corresponds to the second segment 204 is reduced in intensity when compared to the portion of the backlight that corresponds to the segment 202. In this manner, power is conserved by eliminating or reducing the amount of illumination at the portion of the backlight corresponds to the segment 204.

The backlight may be modified by modifying the backlight color or compensating for the non-uniformity of brightness of the backlight. The backlight modification may be based on hardware interpolation of a sparse array and vector multiplication. In particular, when a blocked, darkened, or otherwise occluded segment of the display is determined, a backlight values may be interpolation based on a sparse array of backlight values. Moreover, vector multiplication enables multiple pixel corrections to be calculated and applied to the display image to be rendered in real-time without any perceivable latency.

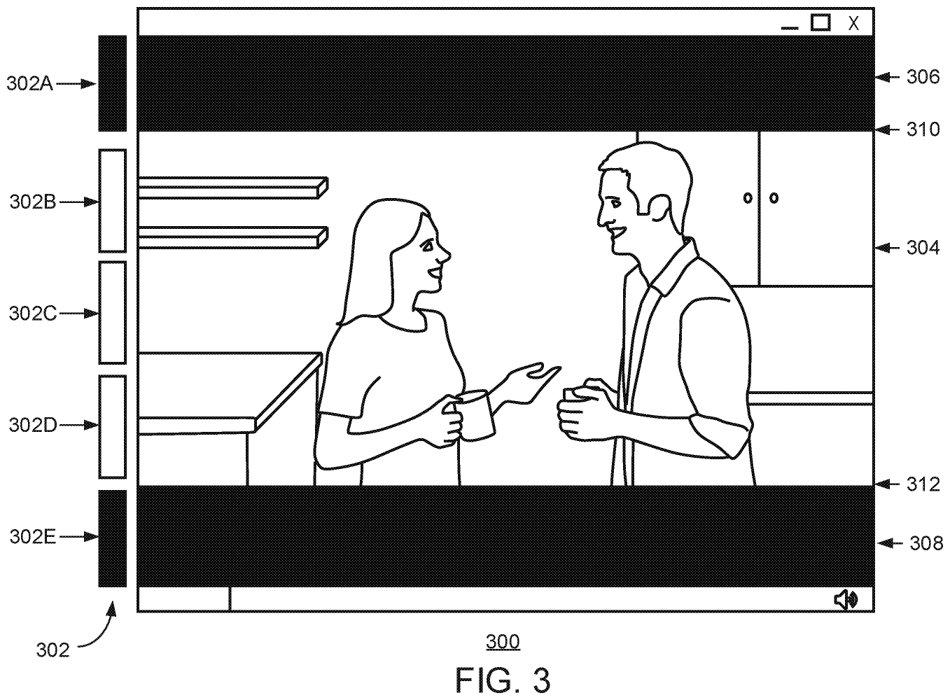

FIG. 3 is an illustration of content rendered on a panel display 300. Similar to FIG. 2, the panel display 300 may be the panel display 110 of FIG. 1. Additionally, in embodiments the panel display 300 may be an LCD display. The panel display 300 may rest on top of a backlight. As illustrated, the panel display 300 includes a first segment 304, a second segment 306, and third segment 308. In the example of FIG. 3, a movie is playing and visual content associated with the movie is rendered in segment 304 of the panel display 300. When rendering the movie, a part of the panel display may remain dark while the movie is playing. Segments of the display device may remain dark to maintain an aspect ratio of the movie as rendered on the display device. In response to this configuration of dark areas on the display device, LEDs of the backlight that correspond closely to the dark segments may be powered off. Powering off dark segments of the panel display can be used to save power and free up processing resources. An image processing function may be applied to portions of the panel display near the segment boundaries 310 and 312 to compensate for artifacts on the panel display due to a reduction in intensity of neighboring areas of the backlight.

As illustrated in FIG. 3, the first segment 304 is used to render a movie scene. However, to maintain a proper aspect ratio for the movie rendered in the first segment 304, second segment 306 and the third segment 308 may be static or otherwise darkened. For examples, a solid black bar may be rendered at the second segment 306 and the third segment 308. According to the present techniques, the backlight controller powers off the segments of the backlight that correspond to the second segment 306 and the third segment 308. In some cases, the backlight corresponding to the second segment 306 and the third segment 308 are reduced in intensity when compared to portion of the backlight that corresponds to the first segment 304.

The example of FIG. 3 also includes a plurality of strings 302. In some cases, a portion of individual solid-state light sources of the backlight are electrically coupled by the same circuitry as indicated by each of the string 302A, string 302B, string 302C, string 302D, and string 302E. Accordingly, a driving signal for the string 302A and the string 302E may indicate that an intensity of the solid-state light sources coupled with the string 302A and 302B are reduced in intensity or are powered off.

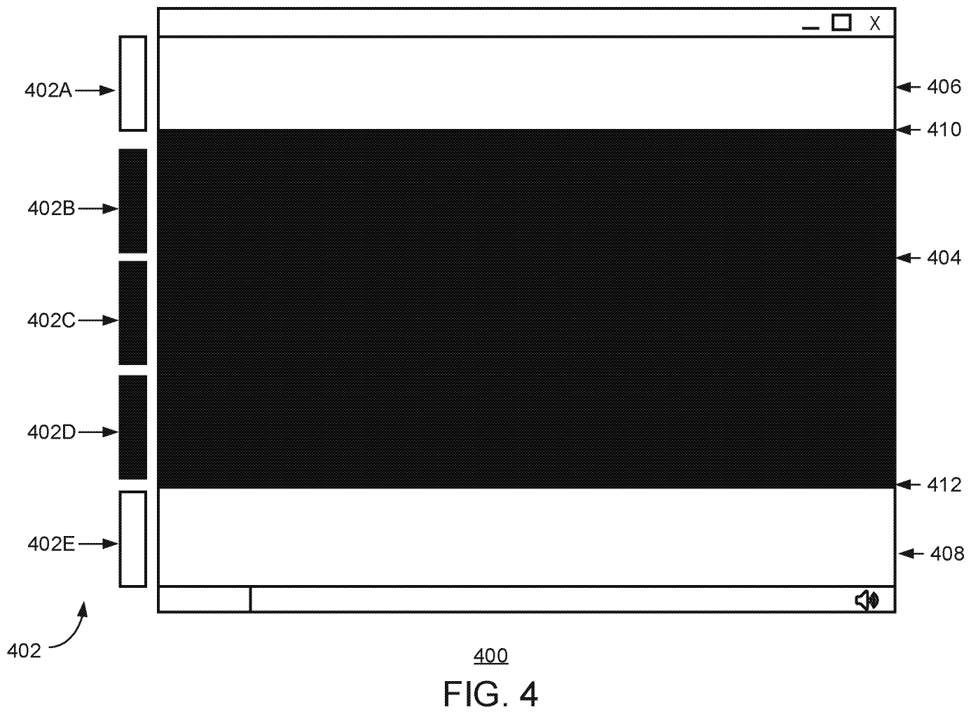

FIG. 4 is an illustration of content rendered on a panel display 400. Similar to FIGS. 2 and 3, the panel display 400 may be the panel display 110 of FIG. 1. Additionally, in embodiments the panel display 400 may be an LCD display. As illustrated, the panel display 400 and corresponding backlight are partitioned into a first segment 404, a second segment 406, and third segment 408. In the example of FIG. 4, an accessory may be physically attached to the panel display device. In particular, an accessory may be physically coupled with the panel display device such that segments of the panel display device that display rendered content are blocked from view. For example, a keyboard or other accessory device may be physically coupled with the panel display at a corresponding segment. The segment of the screen that corresponds to the portion of the panel display occluded by the accessory is darkened or powered off while the accessory is positioned atop of the display. In embodiments, the adaptive low power touch and display device may sense the configuration of the panel display. The configuration may be sensed by a sensor such as a touch sensor. In embodiments, the configuration may be detected via a signal from the accessory via a wireless or wired connection to a system that includes the panel display 400. In response to this configuration, to save power, LEDs in the darkened or occluded segments may be powered off. Moreover, a segment of a touch active area that corresponds to the blocked area of the panel display may also be powered off to save power or improve touch performance. In this manner, the touch functionality is also removed from the darkened or occluded segments as necessary.

The first segment 404 is static or otherwise blocked or occluded. In the example of FIG. 4, the second segment 406 and the third segment 408 may be used to render content. According to the present techniques, the backlight controller powers off the first segment 404. In some cases, first segment 404 is reduced in intensity when compared to the portion of the backlight that corresponds to the second segment 406 and the third segment 408. An image processing function may be applied to portions of the panel display near the segment boundary 410 and 412 to compensate for artifacts on the panel display due to a reduction in intensity of neighboring light sources of the backlight.

The example of FIG. 4 also includes a plurality of strings 402. In some cases, a portion of individual solid-state light sources of the backlight are electrically coupled by the same circuitry as indicated by each of the string 402A, string 402B, string 402C, string 402D, and string 402E. Accordingly, a driving signal for the string 402B, 402C, and 402D may indicate that in intensity of the solid-state light sources coupled with the string 402B, 402C, and 402D are reduced in intensity or are powered off. The backlight according to the present techniques include lights arranged in several formats. For example, the backlight may be in a back-lit, edge-lit format, or direct lit format. In a back-light format, lights are arranged behind the panel display. In an edge-lit format, the lights are arranged along the edge of the panel display. In a direct-lit format, meaning the LEDs are directly behind the display, or lit from multiple sides.

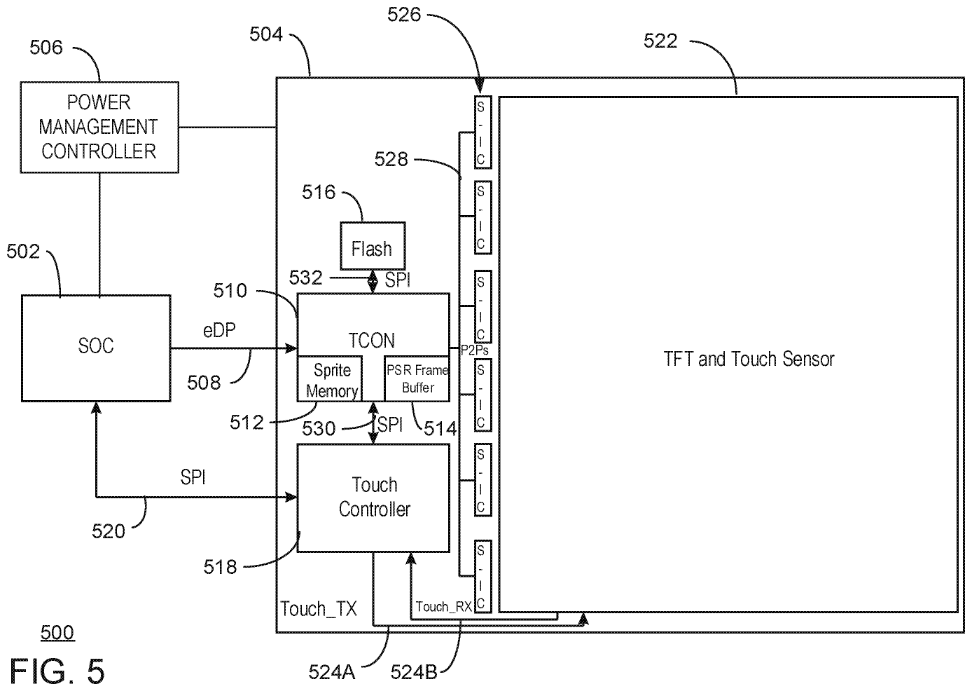

FIG. 5 is an illustration of a system 500 that enables an adaptive low power touch and display device. In particular, the system 500 may enable “super glance mode” at an adaptive low power touch and display device. In a super glance mode, a display device renders content while integrating a “glance mode” of a timing controller with the touch controller. In this manner, a typical glance mode of the timing controller is extended via a touch controller. In the super glance mode, the display device consumes less power when compared to a conventional glance mode. Additionally, in the super glance mode, the display device consumes less power compared to rendering content as processed by a system on chip (SoC).

The system 500 includes an SoC 502, a display device 504, and a power management controller 506. The SoC 502, display device 504, and power management controller 506 may be communicatively coupled to enable functionality described herein, such enabling a reduction in power consumed by the display device, offloading image processing from a CPU/GPU, and a super glance mode.

In embodiments, the SoC 502 may be coupled with the display device 504 via a DP/embedded DP (eDP) interface via an eDP link 508. In particular, the SoC 502 may provide one or more processors and/or memory components to execute an operating system and provide functionality based on inputs to the computing device and/or outputs from the computing device. Additionally, the SoC 502 can include a DP/eDP source for coupling to the display device 504 via an DP/eDP interface to facilitate displaying one or more images on a display, such as panel display. Display device 504 can include a timing controller (TCON) 510. While a TCON is illustrated, the TCON 510 may also be a display driver integrated circuit (DDIC) or other hardware or software-implemented controller for receiving image data from the SoC 502. The timing controller includes a sprite memory 512 and a panel self-refresh (PSR) frame buffer 514.

The display device 504 also includes a flash memory 516. In embodiments, the flash memory 516 may communicate with the TCON 510 via SPI link 532. The flash memory 516 to store a glance image, which may be a high-resolution image for displaying on the panel display 510. Display device 504 may store multiple glance images for display in a slideshow, animation, or video form. In particular, generations of images could be pre-rendered by a CPU or GPU of the SoC. These images can be then in the flash memory 516. The images may also be stored on an onboard memory of the display controller. In the example of FIG. 5, the images may be stored in the onboard memory of the TCON 510. The images may also be stored in a DDIC or another hardware element used to drive the display device.

The display device 504 also includes a touch controller 518. The SoC 502 may be coupled with the touch controller 518 via Serial Peripheral Interface (SPI) link 520. The touch controller 518 is further coupled with a Thin Film Transistor (TFT) and Touch Sensor 522. The TFT and Touch Sensor 522 may be coupled with the TCON 510 via touch transmit and receive lines 524A and 524B. The TCON 510 may drive source driver integrated circuits (ICs) 526 via a link 528. The link 528 represents the transmission means of a data line and at least one control line from the TCON 510 to the source ICs 528. The TCON may also communicate with the touch controller 518 via link 530. In embodiments, the link 530 transmits data according to a serial communication specification.

In embodiments, the TFT and Touch Sensor 522 is arranged atop of a panel display (not illustrated). The panel display may be may be the panel display 120 of FIG. 1. The display device 504 may also include a backlight controller (not illustrated), where the backlight controller is communicatively coupled with a backlight (not illustrated). The backlight controller and backlight of FIG. 5 may be as illustrated in FIG. 1. In embodiments, TFT and Touch sensor 522 may be arranged atop of the panel display and the backlight. Moreover, the TFT and Touch sensor 522 may be integrated with the panel display to realize an in-cell touch panel. The in-cell touch panel includes touch control electrodes for a touch screen panel embedded inside a liquid crystal display. In operation, a touch screen processing function may be used to modify a touch sensitivity or responsiveness of a blocked, static, or darkened portion of the display device.

The power management controller 506, which may be similar to power management controller 106, may control the SoC 502 and/or display device 504 to increase/decrease power to corresponding segments of LEDs. In embodiments, the power management controller 506 may be used to implement a power management scheme where segments of the backlight are turned off in response to being blocked, static, or darkened. In particular, a portion of the panel display may be blocked, static, or darkened during use or operation. For example, the panel display may be blocked when it is positioned behind an object. In this scenario, a user may be willfully blocking a portion of the display. In another scenario, a peripheral device may be coupled with the panel display in a manner that causes segments of the display to be blocked from view. For example, an input device or accessory may be configured to rest on the panel display. The input device or accessory physically contacts the panel display and can block an area of the display equivalent to the footprint of the input device or accessory. In embodiments, the input device or accessory may be configured to communicate or otherwise provide input to the panel display via the TFT and Touch Sensor 522. In embodiments, the peripheral device may be a dial or knob that rests on top of the panel display. The dial or knob may be coupled with the SoC wirelessly, and can control content rendered by the display device via this wireless communication.

The system 500 may enable a super glance mode. The super glance mode enables a user to retrieve and review of notifications at the display device without CPU or GPU interaction. In embodiments, super glance mode extends a conventional glance capability by integrating the touch controller with a TCON glance mode. In particular, in response to a power down by the SoC, a lock screen with notifications may be written to a memory of the display device, such as the flash memory 516. The lock screen with notifications may also be written to sprite memory 512 of the TCON 510. In embodiments, the SoC 502 may also write a list of notifications to a flash memory of the display device. As used herein, a notification refers to a visual indicator that obtains the attention of a user. In embodiments, the notification may be an icon, a message, a reminder, or an alert. A lock screen may be an image or other visual element that is available to a user. Often, the lock screen is provided to a user prior to any authentication of the user. Accordingly, a lock screen is typically accessible to any user of a computing device. In embodiments, a lock image is a static image stored in a device memory prior to power down of the SoC 502.

In response to an event, the TCON 510 can invoke the super glance mode and immediately retrieve one or more images a memory of the display device and transmit the images to a memory or the PSR frame buffers 514. An event may include a power up event, a touch event, or a pen event. For example, a “Wake on touch” event can be configured to display the stored image for the super glance mode upon a touch event. This event may be defined as a particular gesture on the screen, whereas other gestures could wake the SoC. In the case of a foldable device, an event indicating the partial opening of the foldable device may invoke the super glance mode. Opening the foldable device completely could wake the SoC, and can also invoke the super glance mode and cause the display of an image stored for the super glance mode. Moreover, another event is a “wake on pen” event, where a touch controller senses a pen is in range of detection or actually touching the screen. When super glance mode is invoked in response to an event, a first image is retrieved for display prior to booting the SoC 502. This results in quick access to notifications by a user. In response to the event, without the SoC 502 needing to wake, the TCON 510 can retrieve previously stored image of lock screen and list of notifications.

In embodiments, the touch controller can signal the TCON to enable sprite button overlays on the panel display to implement general user interface (UI) elements in super glance mode. As used herein, sprites are pre-stored graphical elements that can be an overlay or placed on top of a display image. These user interface elements include, but are not limited to, next, previous, delete, and the like. In response to enabling sprite button overlays, the TCON overlays the display image with sprite stored in flash memory and TCON SRAM. The touch controller could sense finger or pen touch at locations sprite overlays, allowing user interaction with the display. In particular, the touch controller communicates with TCON to select a notification to be displayed and to allow management of the notification list based on user's selection of user interface elements. In this manner, a richer, instant on, interactive glance mode experience is enabled.

In embodiments, super glance mode is offloaded from a CPU such that secondary or other processors are used to enable image processing while the SOC is powered down or in a low power state. Interrupt sources may trigger display electronics to enable rendering of image content without CPU interaction. This results in an extended battery life. Additionally, interrupts and communication between display electronics and touch electronics enables all graphical user interface (GUI) elements to be rendered on the panel display by a display controller and detected directly by a touch controller or other hardware element distinct from a CPU or GPU. Moreover, a user can retrieve and review of notification without CPU interaction, which further extends battery life. Notifications and user interface (UI) graphical elements could be pre-rendered by CPU or GPU and stored in TCON, DDIC or other hardware element used to drive display. Alternatively, notification images could be rendered on the fly by a touch processor, secondary processor, other hardware element distinct from CPU or GPU.

For ease of description, the example of FIG. 5 illustrates a display device 504 that includes a TCON that drives a plurality of source ICs. However, the present techniques may be implemented using any display controller and display drivers. For example, the present techniques may be executed via a DDIC or other display driver IC.

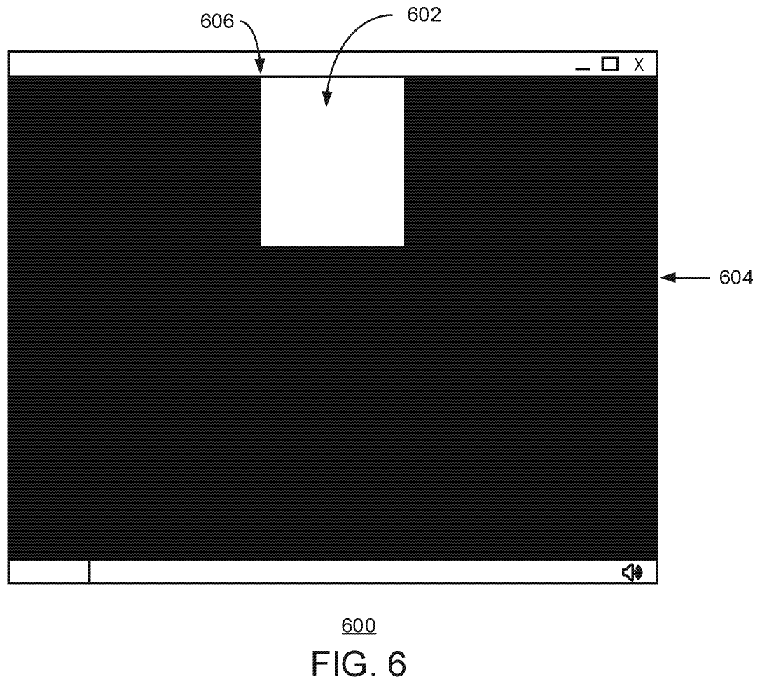

FIG. 6 is an illustration of a virtual track pad 602 on a panel display 600. Similar to FIGS. 2-4, the panel display 600 may be the panel display 110 of FIG. 1. Additionally, in embodiments the panel display 600 may be an LCD display. As illustrated the panel display 600 includes a first segment 602 and a second segment 604. In the example of FIG. 6, a touch controller may be powered on in a corresponding area to the active segment 602 of the panel display and a corresponding segment of the backlight. In particular, a touch sensor may be physically partitioned into an on/active segment and an off/darkened segment. The touch sensor may also be partitioned into an on/active segment and an off/darkened segment via a software or firmware adaptation. In embodiments, the segments of the touch controller correspond to segments of the panel display and the backlight controller.

In embodiments, the touch sensor enables a two-dimensional dimming architecture. In particular, a touch controller can logically scan/excite only the antennas in the track pad area of the touch sensor to save power when compared to powering on, scanning, or exciting the entire area of the touch sensor. Alternatively, a sensing architecture may be configured to support even lower power could have short antennas only spanning track pad area. Alternatively, a sensil architecture could limit the scan area to the track pad area to save power. The sensil architecture may enable the use of in-cell technology where the touch sensor elements are embedded in the display structure.

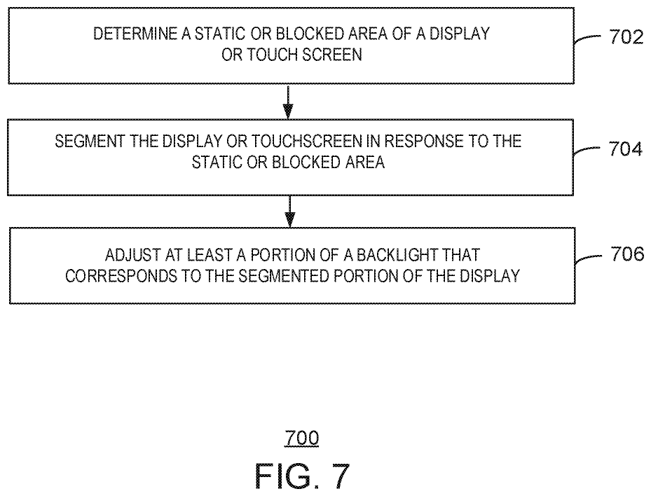

FIG. 7 is a process flow diagram of an example method that enables an adaptive low power touch and display device. The method 700 can be implemented with any suitable computing device, such as the computing system 602 of FIG. 6.

At block 702, the method 700 determining a blocked area of a display or a touch screen. At block 704, a segmented area of the display is derived based on the blocked area of the display or touch screen. At block 706, a portion of a backlight of the display that corresponds to the blocked area of the display is adjusted, wherein the backlight is non-uniform in emitting light.

In one embodiment, the process flow diagram of FIG. 7 is intended to indicate that the steps of the method 700 are to be executed in a particular order. Alternatively, in other embodiments, the steps of the method 700 can be executed in any suitable order and any suitable number of the steps of the method 700 can be included. Further, any number of additional steps may be included within the method 700, depending on the specific application.

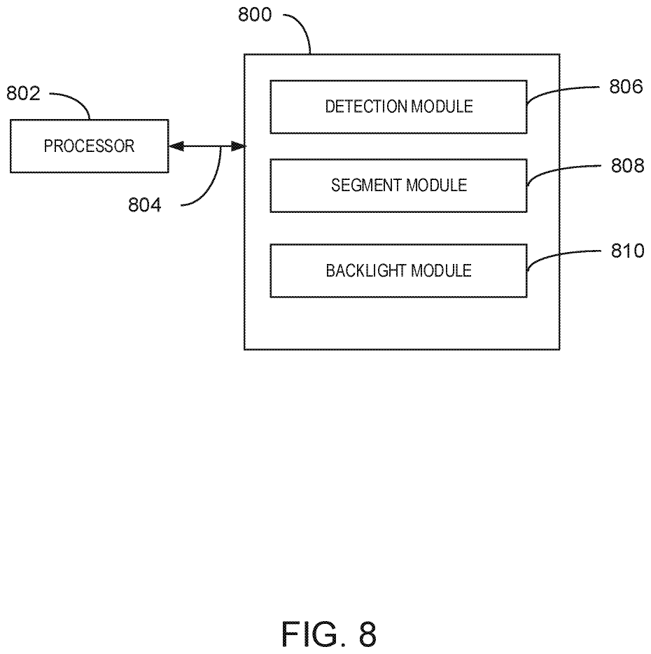

FIG. 8 is a block diagram showing computer readable media 800 that stores code for an adaptive low power touch and display device. The computer readable media 800 may be accessed by a processor 802 over a computer bus 804. Furthermore, the computer readable medium 800 may include code configured to direct the processor 802 to perform the methods described herein. In some embodiments, the computer readable media 800 may be non-transitory computer readable media. In some examples, the computer readable media 800 may be storage media.

The various software components discussed herein may be stored on one or more computer readable media 800, as indicated in FIG. 8. For example, a detection module 806 may be configured to determine a blocked or static segment of a display device or a touch screen of the display device. A segment module 808 can be configured to segment areas of the display or a touch screen of the display based on the blocked or static areas of the display or the touch screen. A backlight module 810 may be configured to adjust segments of the backlight. In embodiments, the adjusted segments of the display correspond to the blocked, static, or darkened areas of the display.

The block diagram of FIG. 8 is not intended to indicate that the computer readable media 800 is to include all of the components shown in FIG. 8. Further, the computer readable media 800 may include any number of additional components not shown in FIG. 8, depending on the details of the specific implementation.

FIG. 9 is a block diagram of an example of a computing system that can be used to enable an adaptive low power touch and display device. The example system 900 includes a computing device 902. The computing device 902 includes a processing unit 904, a system memory 906, and a system bus 908. In some examples, the computing device 902 can be a gaming console, a personal computer (PC), an accessory console, a gaming controller, among other computing devices. In some examples, the computing device 902 can be a node in a cloud network.

The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure, including the memory bus or memory controller, a peripheral bus or external bus, and a local bus using any variety of available bus architectures known to those of ordinary skill in the art. The system memory 906 includes computer-readable storage media that includes volatile memory 910 and nonvolatile memory 912.

The basic input/output system (BIOS), containing the basic routines to transfer information between elements within the computer 902, such as during start-up, is stored in nonvolatile memory 912. By way of illustration, and not limitation, nonvolatile memory 912 can include read-only memory (ROM), programmable ROM (PROM), electrically programmable ROM (EPROM), electrically erasable programmable ROM (EEPROM), or flash memory.

Volatile memory 910 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 902 also includes other computer-readable media, such as removable/non-removable, volatile/non-volatile computer storage media. FIG. 9 shows, for example a disk storage 914. Disk storage 914 includes, but is not limited to, devices like a magnetic disk drive, floppy disk drive, tape drive, Jaz drive, Zip drive, flash memory card, or memory stick.

In addition, disk storage 914 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 914 to the system bus 908, a removable or non-removable interface is typically used such as interface 916.

It is to be appreciated that FIG. 9 describes software that acts as an intermediary between users and the basic computer resources described in the suitable operating environment 900. Such software includes an operating system 918. Operating system 918, which can be stored on disk storage 914, acts to control and allocate resources of the computer 902.

System applications 920 take advantage of the management of resources by operating system 918 through program modules 922 and program data 924 stored either in system memory 906 or on disk storage 914. It is to be appreciated that the disclosed subject matter can be implemented with various operating systems or combinations of operating systems.

A user enters commands or information into the computer 902 through input devices 926. Input devices 926 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, any suitable dial accessory (physical or virtual), and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. A NUI device may include a touch screen based on the TFT and Touch Sensor 522 of FIG. 5. NUI devices include devices relying on speech recognition, touch and stylus recognition, gesture recognition both on panel display and adjacent to the panel display, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 926 connect to the processing unit 904 through the system bus 908 via interface ports 928. Interface ports 928 include, for example, a serial port, a parallel port, a game port, and a universal serial bus (USB).

Output devices 930 use some of the same type of ports as input devices 926. Thus, for example, a USB port may be used to provide input to the computer 902 and to output information from computer 902 to an output device 930.

Output adapter 932 is provided to illustrate that there are some output devices 930 like monitors, speakers, and printers, among other output devices 930, which are accessible via adapters. The output adapters 932 include, by way of illustration and not limitation, video and sound cards that provide a means of connection between the output device 930 and the system bus 908. It can be noted that other devices and systems of devices provide both input and output capabilities such as remote computing devices 934.

The computer 902 can be a server hosting various software applications in a networked environment using logical connections to one or more remote computers, such as remote computing devices 934. The remote computing devices 934 may be client systems configured with web browsers, PC applications, mobile phone applications, and the like. The remote computing devices 934 can be a personal computer, a server, a router, a network PC, a workstation, a microprocessor-based appliance, a mobile phone, a peer device or other common network node and the like, and typically includes many or all of the elements described relative to the computer 902. In some embodiments, the remote computing devices 934 can also include any suitable fabrication device that can manufacture a fabric such as a fabric that passes colonnaded light as described herein.

Remote computing devices 934 can be logically connected to the computer 902 through a network interface 936 and then connected via a communication connection 938, which may be wireless. Network interface 936 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 938 refers to the hardware/software employed to connect the network interface 936 to the bus 908. While communication connection 938 is shown for illustrative clarity inside computer 902, it can also be external to the computer 902. The hardware/software for connection to the network interface 936 may include, for exemplary purposes, internal and external technologies such as, mobile phone switches, modems including regular telephone grade modems, cable modems and DSL modems, ISDN adapters, and Ethernet cards.

The computer 902 can further include a radio 940. For example, the radio 940 can be a wireless local area network radio that may operate one or more wireless bands. For example, the radio 940 can operate on the industrial, scientific, and medical (ISM) radio band at 2.4 GHz or 5 GHz. In some examples, the radio 940 can operate on any suitable radio band at any radio frequency.

The output device 530 may be a display device as described herein. The display device may include modules such as detection manager 942, and a segment manager 944, and a backlight manager 946. In some embodiments, the detection manager 942 detects a blocked or static area of the display device. The segment manager 944 segments the static or blocked area of the display. The backlight manager may adjust segments of the backlight that correspond to blocked or otherwise static areas of the display.

It is to be understood that the block diagram of FIG. 9 is not intended to indicate that the computing system 902 is to include all of the components shown in FIG. 9. Rather, the computing system 902 can include fewer or additional components not illustrated in FIG. 9 (e.g., additional applications, additional modules, additional memory devices, additional network interfaces, etc.).

### EXAMPLES

Example 1 is a method. The method includes determining a blocked area of a panel display, wherein the panel display is to render one or more images; deriving a segmented area of the display based on the blocked area of the display; adjusting a segment of a backlight of the panel display that is proximate to the blocked area of the panel display according to a sparse array configuration, wherein the backlight is non-uniform in emitting light.

Example 2 includes the method of example 1, including or excluding optional features. In this example, the one or more images is corrected to compensate for a non-uniform illumination of the backlight.

Example 3 includes the method of any one of examples 1 to 2, including or excluding optional features. In this example, determining the blocked area of the panel display comprises transmitting a signal from an accessory that is physically coupled with the panel display.

Example 4 includes the method of any one of examples 1 to 3, including or excluding optional features. In this example, determining the blocked area of the panel display comprises detecting, by a sensor, the blocked area of the panel display.

Example 5 includes the method of any one of examples 1 to 4, including or excluding optional features. In this example, a touch subsystem detects an accessory coupled with the panel display and initiates a power saving scheme.

Example 6 includes the method of any one of examples 1 to 5, including or excluding optional features. In this example, an active area of the panel display is configured as a virtual track pad and a corresponding segment of a touch screen is enabled to interpret a touch input of the virtual track pad.

Example 7 includes the method of any one of examples 1 to 6, including or excluding optional features. In this example, in response to adjusting a segment of a backlight of the panel display that corresponds to the blocked area of the panel display, a display controller dynamically resizes the one or more images to conform to an active segment of the panel display.

Example 8 includes the method of any one of examples 1 to 7, including or excluding optional features. In this example, in response to powering on a system on chip, a display controller is to render a lock screen and a notification.

Example 9 includes the method of any one of examples 1 to 8, including or excluding optional features. In this example, rendering the one or more images is offloaded from a processor to a display controller.

Example 10 includes the method of any one of examples 1 to 9, including or excluding optional features. In this example, in response to the panel display being unblocked gradually restore rendered content to the formerly blocked area.

Example 11 is a system. The system includes a display controller, wherein a panel display is to render images; a touch screen controller, wherein a touch screen is to interpret a touch input; and a backlight controller, wherein a segment of a backlight that corresponds to a blocked area of the panel display is adjusted according to a sparse array configuration, and wherein the backlight is non-uniform in emitting light.

Example 12 includes the system of example 11, including or excluding optional features. In this example, the backlight comprises a plurality of strings that are in proximity to the blocked area of the panel display.

Example 13 includes the system of any one of examples 11 to 12, including or excluding optional features. In this example, the touch screen is configured as a virtual track pad, wherein the touch screen scans antennas in a track pad area and ignores antennas outside of the track pad area.

Example 14 includes the system of any one of examples 11 to 13, including or excluding optional features. In this example, the display controller enables a retrieval and review of notifications without a CPU interaction.

Example 15 includes the system of any one of examples 11 to 14, including or excluding optional features. In this example, the backlight controller dynamically adjusts an intensity of the backlight in response of a blocked, static, or darkened segment of the panel display.

Example 16 is a computer readable medium bearing computer executable instructions, which when executed on a computing system comprising at least a processor, carry out a method that enables an adaptive low power touch and display module. The computer-readable medium includes instructions that direct the processor to determine a blocked area of a panel display, wherein the panel display is to render one or more images; derive a segmented area of the display based on the blocked area of the display; and adjust a segment of a backlight of the panel display that corresponds to the blocked area of the panel display according to a sparse array configuration, wherein the backlight is non-uniform in emitting light.

Example 17 includes the computer-readable medium of example 16, including or excluding optional features. In this example, the computer-readable medium includes adjusting a segment of a touch active area that corresponds to the blocked area of the panel display, wherein the touch active area that corresponds to the blocked area of the panel display is powered off or otherwise disabled.

Example 18 includes the computer-readable medium of any one of examples 16 to 17, including or excluding optional features. In this example, determining the blocked area of the panel display comprises transmitting a signal from an accessory that is physically coupled with the panel display.

Example 19 includes the computer-readable medium of any one of examples 16 to 18, including or excluding optional features. In this example, determining the blocked area of the panel display comprises detecting, by a sensor, the blocked area of the panel display.

Example 20 includes the computer-readable medium of any one of examples 16 to 19, including or excluding optional features. In this example, a touch subsystem detects an accessory coupled with the panel display and initiates a power saving scheme.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A method, comprising:
determining a blocked area of a panel display, wherein the panel display is to render one or more images;
deriving a segmented area of the display based on the blocked area of the display;
adjusting a segment of a backlight of the panel display that is proximate to the blocked area of the panel display according to a sparse array configuration, wherein a luminance of discrete light sources of the backlight correspond to a sparse array of backlight values and the backlight is non-uniform in emitting light.

2. The method of claim 1, wherein the one or more images is corrected to compensate for a non-uniform illumination of the backlight.

3. The method of claim 1, wherein determining the blocked area of the panel display comprises transmitting a signal from an accessory that is physically coupled with the panel display.

4. The method of claim 1, wherein determining the blocked area of the panel display comprises detecting, by a sensor, the blocked area of the panel display.

5. The method of claim 1, wherein a touch subsystem detects an accessory coupled with the panel display and initiates a power saving scheme.

6. The method of claim 1, wherein an active area of the panel display is configured as a virtual track pad and a corresponding segment of a touch screen is enabled to interpret a touch input of the virtual track pad.

7. The method of claim 1, wherein in response to adjusting a segment of a backlight of the panel display that corresponds to the blocked area of the panel display, a display controller dynamically resizes the one or more images to conform to an active segment of the panel display.

8. The method of claim 1, wherein in response to powering on a system on chip, a display controller is to render a lock screen and a notification.

9. The method of claim 1, wherein rendering the one or more images is offloaded from a processor to a display controller.

10. The method of claim 1, wherein in response to the panel display being unblocked gradually restore rendered content to the formerly blocked area.

11. A system, comprising:
a display controller, wherein a panel display is to render images;
a touch screen controller, wherein a touch screen is to interpret a touch input; and
a backlight controller, wherein a segment of a backlight that corresponds to a blocked area of the panel display is adjusted according to a sparse array configuration and a luminance of discrete light sources of the backlight correspond to a sparse array of backlight values, and wherein the backlight is non-uniform in emitting light.

12. The system of claim 11, wherein the backlight comprises a plurality of strings that are in proximity to the blocked area of the panel display.

13. The system of claim 11, wherein the touch screen is configured as a virtual track pad, wherein the touch screen scans antennas in a track pad area and ignores antennas outside of the track pad area.

14. The system of claim 11, wherein the display controller enables a retrieval and review of notifications without a CPU interaction.

15. The system of claim 11, wherein the backlight controller dynamically adjusts an intensity of the backlight in response of a blocked, static, or darkened segment of the panel display.

16. Computer readable storage media bearing computer executable instructions which, when executed on a computing system comprising at least a processor, carry out a method for an adaptive low power touch and display module, the method comprising:
determining a blocked area of a panel display, wherein the panel display is to render one or more images;
deriving a segmented area of the display based on the blocked area of the display;
adjusting a segment of a backlight of the panel display that corresponds to the blocked area of the panel display according to a sparse array configuration, wherein the backlight is non-uniform in emitting light.

17. The computer readable storage media of claim 16, comprising:
adjusting a segment of a touch active area that corresponds to the blocked area of the panel display, wherein the touch active area that corresponds to the blocked area of the panel display is powered off or otherwise disabled.

18. The computer readable storage media of claim 16, wherein determining the blocked area of the panel display comprises transmitting a signal from an accessory that is physically coupled with the panel display.

19. The computer readable storage media of claim 16, wherein determining the blocked area of the panel display comprises detecting, by a sensor, the blocked area of the panel display.

20. The computer readable storage media of claim 16, wherein a touch subsystem detects an accessory coupled with the panel display and initiates a power saving scheme.
